(19) United States
(12) Patent Application Publication
(10) Pub. No.: US 2006/0120350 A1
(43) Pub. Date: Jun. 8, 2006

(54) Method and apparatus voice transcoding in a VoIP environment

(76) Inventors: Keith A. Olds, Melbourne, FL (US); Barbara M. DeSutter, Phoenix, AZ (US); Leonard Pennock, Chandler, AZ (US); Joseph C. Sligo, Chandler, AZ (US)

Correspondence Address: MOTOROLA, INC., 1303 EAST ALGONQUIN ROAD, IL01/3RD, SCHAUMBURG, IL, 60196, US

(21) Appl. No.: 11/005,276

(22) Filed: Dec. 6, 2004

(51) Int. Cl. H04L 12/66; H04J 3/22; H04J 3/16

(52) U.S. Cl. 370/352; 370/466

(57) ABSTRACT

Various embodiments are described to address the need for a method and apparatus of voice transcoding in a VoIP environment that effectively interconnects multiple voice encoding formats. In general, a packet-based tandem transcoder (201) receives (706) packets that include vocoder data frames in which source voice samples have been encoded according to a first vocoding format. The transcoder then decodes (708) the vocoder data frames to produce a sequence of linear speech samples. Using a non-circuit switched communication path, an encoder obtains (710) linear speech samples from the sequence of linear speech samples and encodes (712) groups of speech samples from the sequence of linear speech samples to produce vocoder data frames according to a second vocoding format.

### REFERENCE(S) TO RELATED APPLICATION(S)

This application is related to a co-pending application Ser. No. 10/733,209, entitled “METHOD FOR ASSIGNING TRANSCODING CHANNEL ELEMENTS,” filed Dec. 10, 2003, which is assigned to the assignee of the present application.

This application is related to a co-pending application Ser. No. 10/053,338, entitled “COMMUNICATION EQUIPMENT, TRANSCODER DEVICE AND METHOD FOR PROCESSING FRAMES ASSOClATED WITH A PLURALITY OF WIRELESS PROTOCOLS,” filed Oct. 25, 2001, which is assigned to the assignee of the present application.

### FIELD OF THE INVENTION

The present invention relates generally to communication systems and, in particular, to voice transcoding in a voice-over-internet-protocol (VoIP) environment.

### BACKGROUND OF THE INVENTION

Networks that support multiple access technologies often require the ability to translate from one voice format to another. This is especially true with wireless technologies that use voice compression to maximize their bandwidth efficiency. While it is theoretically possible to devise an algorithm that can directly translate from one compressed voice format to another, the common practice is to use tandem vocoding. In tandem vocoding, the received compressed voice is first decoding into an uncompressed format, typically the International Telecommunication Union (ITU) G.711 voice format. This uncompressed voice is then re-encoded into the same or another compressed voice format. It has been common to use tandem vocoding whenever two mobile phones are connected in a call, but the cellular industry is rapidly deploying systems with “tandem free operation” that avoid the need for tandem vocoding when both call ends use the same speech format. However, when the call ends are connected to different access technologies, for example IS-2000 CDMA to GSM, tandem vocoding is still necessary because the mobile phones use different compressed voice formats. Typically in these cases, the voice is decoded to G.711 in one transcoder and the uncompressed voice is sent over the Public Switched Telephone Network (PSTN) to a transcoder that re-encodes it to the other voice format before it is transmitted to the other mobile phone. The mobile switches that connect to the PSTN and the switches in PSTN are responsible for interconnecting these two transcoders.

Transcoders used in today's cellular and Personal Communications Service (PCS) systems translate a call's voice bearer between a highly compressed voice format used in the wireless system and a PSTN voice format, which is generally G.711. FIG. 1 provides an example of a traditional transcoder 100, as implemented on a digital signal processor (DSP) board. Today's transcoders are built with the assumption that they will be used in a circuit-switched network. This is true even when internet protocol (IP) backhaul is used to transport the voice bearer (see the IP Voice Packets of FIG. 1, e.g.) between the wireless base station and the transcoder. In addition, the PSTN uses a circuit-switched, time division multiplexing (TDM) transport structure for its bearer traffic (see the TDM Voice Packets of FIG. 1, e.g.). Thus, when tandem vocoding connections are needed between traditional transcoders, the circuit-switched, TDM circuit structure is relied on to connect the vocoders.

As the convergence of voice and data systems continues, the application of VoIP is emerging as the technology of choice for the core network bearer that ties the various access networks together. These core networks interconnect various access networks by using a variety of signaling and bearer interworking gateways, which transport the voice as IP packets using packet routing instead of circuit switching. An access network may employ any of a range of wireless or wire line technologies to make the final connection to a user. The bearer (or media) gateways convert the VoIP used in the core network to the format needed in the particular access network. In a system of this type, the PSTN can be considered another access network, and the core only need convert to the circuit switched, TDM formats when the PSTN is used for one end of a call. Other access networks use other technologies. For example 2G cellular systems tend to use circuit switching, but they also compress the voice into packet-like structures that are much different from the traditional TDM used in the PSTN. Newer technologies such as Cable Modem or Wireless LAN remain packet switched and VoIP throughout. Thus, as these core networks are faced with interconnecting an ever-increasing variety of voice encoding and transport (packet) formats, translation between these formats becomes a significant challenge.

One approach to meeting this challenge is to follow the PSTN precedent and translate to and from a common format at the edge of the network. The system would then always use this common format within the core. In traditional transcoders, however, the practice of using TDM circuit switching creates a bandwidth capacity bottleneck, limits the flexibility of the transcoder, and also reduces the bandwidth efficiency with which the voice information is transported through the network. It is expected that any arbitrary, “one-size-fits-all” common format will suffer from one or more of these drawbacks.

Accordingly, it would be desirable to have a method and apparatus for voice transcoding in a VoIP environment that effectively interconnects multiple voice encoding formats without a number of the drawbacks inherent to the well-known approaches.

### BRIEF DESCRIPTION OF THE DRAWINGS

FIG. 1 is a block diagram depiction of a traditional transcoder, as implemented on a digital signal processor (DSP) board, in accordance with the prior art.

FIG. 2 is a block diagram depiction of a packet-based tandem transcoder within a communication network, in accordance with multiple embodiments of the present invention.

FIG. 3 is a block diagram depiction of a control hierarchy in a packet-based tandem transcoder, in accordance with multiple embodiments of the present invention.

FIG. 4 is a block diagram depiction of components included within a channel element, in accordance with multiple embodiments of the present invention.

FIG. 5 is a block diagram depiction of a packet-based tandem transcoder in which each of the vocoder/transceivers that form each channel element are implemented on a single DSP, in accordance with some embodiments of the present invention.

FIG. 6 is a block diagram depiction of a packet-based tandem transcoder in which the vocoder/transceivers that form channel elements are implemented on multiple DSPs, in accordance with other embodiments of the present invention.

FIG. 7 is a logic flow diagram of functionality performed by one or more packet-based tandem transcoders, in accordance with multiple embodiments of the present invention.

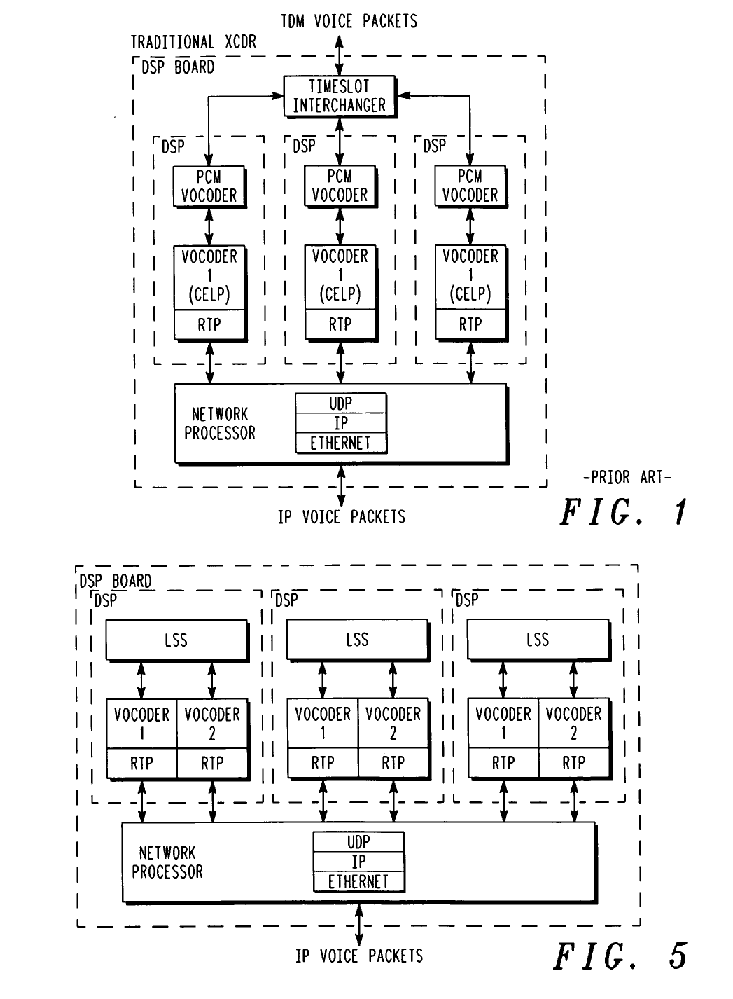

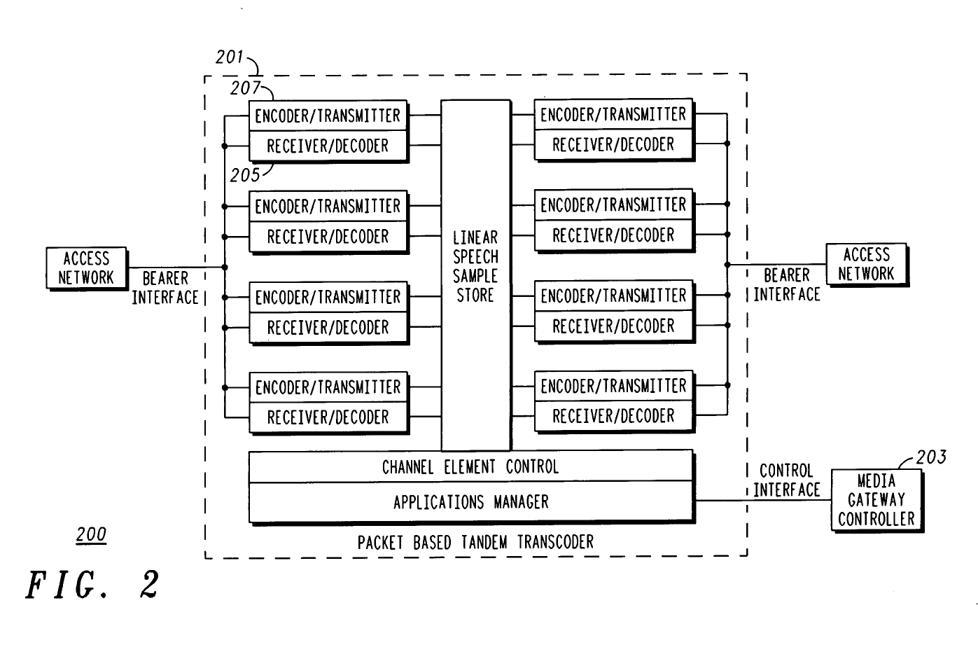

Specific embodiments of the present invention are disclosed below with reference to FIGS. 2-7. Both the description and the illustrations have been drafted with the intent to enhance understanding. For example, the dimensions of some of the figure elements may be exaggerated relative to other elements, and well-known elements that are beneficial or even necessary to a commercially successful implementation may not be depicted so that a less obstructed and a more clear presentation of embodiments may be achieved. Simplicity and clarity in both illustration and description are sought to effectively enable a person of skill in the art to make, use, and best practice the present invention in view of what is already known in the art. One of skill in the art will appreciate that various modifications and changes may be made to the specific embodiments described below without departing from the spirit and scope of the present invention. Thus, the specification and drawings are to be regarded as illustrative and exemplary rather than restrictive or all-encompassing, and all such modifications to the specific embodiments described below are intended to be included within the scope of the present invention.

### DETAILED DESCRIPTION OF EMBODIMENTS

Various embodiments are described to address the need for a method and apparatus of voice transcoding in a VoIP environment that effectively interconnects multiple voice encoding formats. In general, a packet-based tandem transcoder receives packets that include vocoder data frames in which source voice samples have been encoded according to a first vocoding format. The transcoder then decodes the vocoder data frames to produce a sequence of linear speech samples. Using a non-circuit switched communication path, an encoder obtains linear speech samples from the sequence of linear speech samples and encodes groups of speech samples from the sequence of linear speech samples to produce vocoder data frames according to a second vocoding format.

An overview of many of the embodiments described herein follows. However, while this overview contains details that do not apply to many of the embodiments, it also omits various substantial aspects of certain embodiments. A packet-based tandem transcoder, as described in greater detail below, translates between access technologies in a VoIP core network by inserting a channel element into the bearer path of a call. An access technology format generally includes a voice encoding format and a packet payload format. For example, the packets may be RTP packets carried over UDP/IP. The transcoder provides a large number of simultaneous channel elements. It dynamically assembles and inserts channel elements on demand so the mix of vocoders and packet formats that are used in the channel elements at any time depends on the current traffic.

The transcoder supports a set of vocoder/transceiver algorithms each of which contains a receiver/decoder and an encoder/transmitter. Connecting two of these vocoder/transceiver algorithms in tandem forms a channel element. Unlike previous transcoder designs, however, in this architecture the tandem connection is not accomplished with a switch fabric. Instead the connection is made by establishing a common voice format at the output of the decoders and the input to the encoders and using a common data store for the voice data at this point.

Generally, the channel element operates as follows. A receiver/decoder receives a packet from one access technology and processes the packet to extract its payload and recover the vocoder data frames or samples, decodes this data into a block of linear speech samples (LSSs) and stores the LSS block. When LSSs are available, encoder/transmitter retrieves a set of the LSSs (a decoded block and the encoded set will seldom have the same number of LSSs) and encodes it into a frame or sample. A group of these frames or samples are then packed into a packet payload, encapsulated into a packet and transmitted. Since each receiver/decoder is paired with a corresponding encoder/transmitter, the channel element is bi-directional. The packet timing is resynchronized at the transcoder interfaces, so the voice processing does not have to be a real-time operation.

In general, this transcoding approach can convert between the two or more required formats for a call at one place in the bearer path. This place may be at the access network/core network interface or it may be placed within the core network. In addition, the transcoder uses a native VoIP architecture, which avoids the limitations imposed by TDM and circuit switching.

A description of certain embodiments in greater detail follows with reference to FIGS. 2-7. FIG. 2 is a block diagram depiction of a packet-based tandem transcoder within communication network 200, in accordance with multiple embodiments of the present invention. Packet-based tandem transcoder 201 operates under the control of an external media gateway controller 203. When a call is established, media gateway controller 203 determines which voice and packet formats should be used in the call based on the capabilities of the endpoints, the access technologies, and some optimality criteria. Media gateway controller 203 instructs transcoder 201 to insert a channel element into the call to perform the appropriate translation.

An access technology voice bearer packet format generally consists of a voice encoding format and a packet payload format carried over lower level transport, network, and data link protocols. In modern core networks, which rely on VoIP technologies, the packets will generally be RTP packets carried over UDP/IP/Ethernet. Packet-based tandem transcoder 201 is depicted as operating in just such a core network environment. However, some access technologies may use other packet based protocols to transport the voice bearer packets. Those skilled in the art will recognized that embodiments of the present invention are not limited to any particular types of packet protocols.

Transcoder 201 supports a number of vocoder/transceiver functions each of which contains a receiver/decoder and an encoder/transmitter. Transcoder 201 forms a channel element by associating two of these vocoder/transceiver functions in tandem, so that the receiver/decoder (205, e.g.) of one vocoder/transceiver function is connected to the encoder/transmitter (207, e.g.) of the other vocoder/transceiver function. In prior art transcoders, the tandem association is formed through a TDM switch fabric included in the transcoder or through the PSTN, which in this context may be viewed as a widely distributed TDM switch fabric. As described in greater detail below, packet-based tandem transcoder 201 avoids the use of TDM or a TDM switch fabric. Moreover, prior art transcoders do not have the explicit association of the packet processing functions represented by the transceiver and the voice processing functions represented by the vocoder.

FIG. 3 is a block diagram depiction of a control hierarchy 300 in a packet-based tandem transcoder, in accordance with multiple embodiments of the present invention. In these embodiments, the packet-based tandem transcoder is implemented on a distributed computing platform comprising a central control function and a group of signal processing functions. More specifically, as depicted in FIG. 3, control hierarchy 300 involves digital signal processors (DSPs) on DSP circuit boards, each circuit board being controlled by a board control processor (303, e.g.) and the group of board control processors (303-306) being controlled by an application manager (301).

In these embodiments, application manager 301 communicates with the media gateway controller and receives the request to insert a channel element into a call, along with the information about what channel element attributes are needed. Application manager 301 also determines which DSP board can best support the channel element. This decision is primarily based on how busy the various boards are (in those embodiments where each board can support all of the offered channel element types). Once a DSP board is selected, application manager 301 sends the channel element attribute information to the board control processor (BCP) on the selected board.

The BCP on the selected board (BCP 303, e.g.) determines which DSP or set of DSPs will perform the channel element processing. The choice depends on how busy the DSPs are, what they are already doing, and how complex the requested channel element is. In certain embodiments, each DSP is used to create a number of channel elements, all of the same type. The number of channel elements that a single DSP can create depends on the complexity of the vocoder/transceiver functions associated with that type of channel element.

In some embodiments, BCP 303 would first determine whether there is already a DSP with the requested channel element and some idle capacity. If so, BCP 303 would assign the new channel element to that DSP. If there is not a DSP that already has the requested channel element type, BCP 303 would take action to configure a DSP, which is not otherwise engaged, to execute the requested channel element type. In some embodiments, all DSPs will already have the software necessary to run any channel element type, so DSP configuring would simply involve commanding the DSP to activate two of the available vocoder/transceivers to form the desired channel element type. In other embodiments, BCP 303 would download to the DSP a software image containing the two vocoder/transceivers for the desired channel element type.

Once configured with the channel element type, the DSP is responsible for operating the set of individual channel elements as commanded by BCP 303. The DSP activates a channel element when commanded to do so by BCP 303. This involves BCP 303 sending the command to the DSP to activate the channel element along with any particular channel element parameters to further specify the channel element definition for a particular call. Examples of channel element parameters include parameters such as limits on packet sizes, packet rates, jitter tolerance windows, and vocoder modes (if multiple modes are supported).

Once the channel element is active, BCP 303 reports instructions on how to send packets to the channel element to application manager 301, which forwards them to the media gateway controller, which in turn forwards them to the call endpoints. In some embodiments, such as those used in a VoIP core networks, these instructions consist of the IP addresses and UDP port numbers associated with the channel element. For embodiments that operate with other packet transport technologies, these instructions would include addressing consistent with those technologies. Also, some embodiments would allow the transcoder to communicate these instructions directly to the call endpoints rather than relaying them through a media gateway controller. Once activated, the DSP will continue to operate a channel element until it is commanded by BCP 303 to deactivate the channel element. This command typically comes when application manager 301 receives notice from the media gateway controller that the call has terminated and relays this notice to BCP 303.

In addition to those already described, there are several other embodiments related to the control hierarchy depicted in FIG. 3. For example, the BCPs can be eliminated all together by having the application manager directly manage the DSPs. Alternatively, the BCPs may be retained in the hierarchy, but instead of controlling a single DSP board, a BCP could be implemented to control the DSPs on multiple boards.

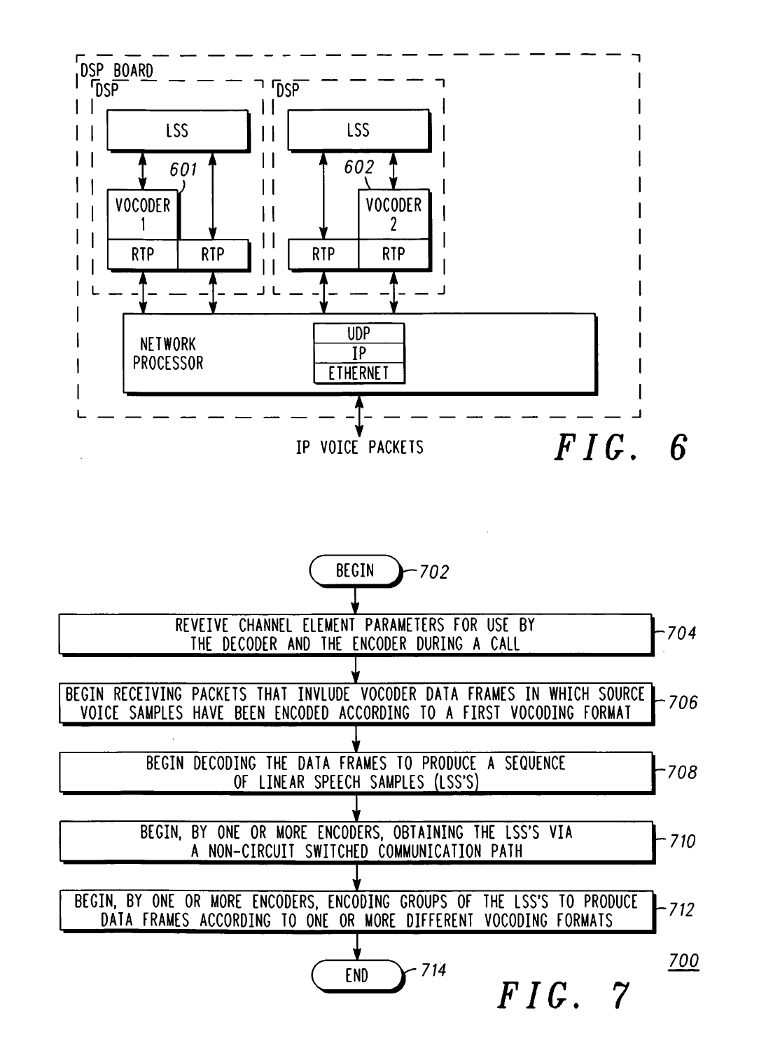

FIG. 5 is a block diagram depiction of packet-based tandem transcoder 500 in which each of the vocoder/transceivers (1 and 2 of each pair, e.g.) that form each channel element are implemented on a single DSP. However, in other embodiments, more than one DSP may be used to create the channel elements. FIG. 6 is a block diagram depiction of packet-based tandem transcoder 600 in which the vocoder/transceivers (601 and 602, e.g.) that form the channel elements are implemented on multiple DSPs. Thus, for example, two DSPs may be used where one runs a set of one type of vocoder/transceiver channels and a second DSP runs a set of a different type of vocoder/transceiver channels. The two DSPs may be interconnected by a non-circuit switched communication path such as a packet-switched network or a data bus (an inter-DSP signaling bus, e.g.) that also provides access for both DSPs to a linear speech sample (LSS) store, which may be in the memory associated with one or the other DSPs or in a shared memory.

A dual DSP configuration is expected to have a capacity advantage over the single DSP configuration when the transcoder includes vocoder/transceiver functions that are so computationally demanding that a single DSP can only run a few channels. The single DSP configuration has better capacity when the computational complexity of the vocoder/transceiver functions is moderate so that a single DSP can run a relatively large number of channel elements. In some embodiments, then, the BCP (or application manager) selects one or more DSPs to operate a channel element type depending on which approach will provide the best capacity.

In addition to single and dual DSP configurations, some embodiments may also accommodate calls that involve three or more DSPs. In particular, multi-party calls such as conference calls, dispatch calls, and/or push-to-talk (PTT) calls may require that vocoded voice from a source be received and decoded into linear speech samples and then encoded into a variety of target voice and packet formats for each of the target legs of the multi-party call. Thus, a receiver/decoder may be implemented on one DSP while other DSPs implement one or more of the needed encoder/transmitters.

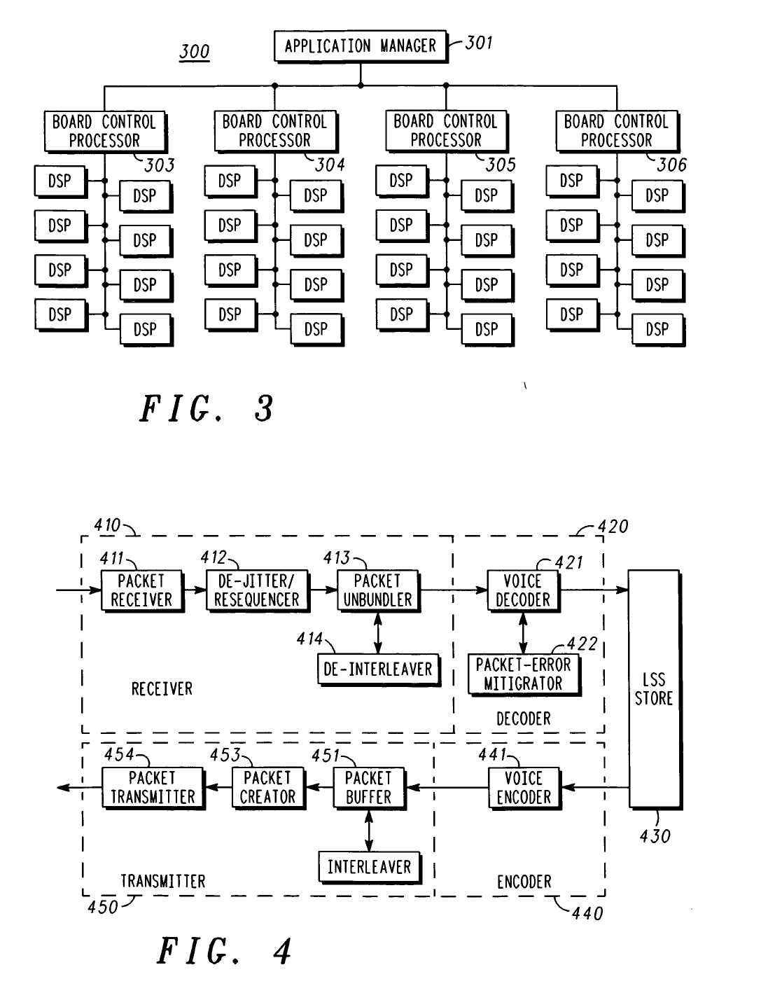

Channel elements have been mentioned many times above with respect to various embodiments of the present invention. FIG. 4 is a block diagram depiction of components that may be included within particular channel elements. A receiver/decoder (410/420) receives a packet from one access technology and processes the packet to extract its payload and recover the vocoder data frames or samples, decodes this data into a block of linear speech samples (LSS) and stores the LSS block into the LSS store 430. When enough LSSs are available, encoder/transmitter (440/450) retrieves a set of the LSSs (a decoded block and the encoded set will seldom have the same number of LSSs) and encodes it into a frame or sample. A group of these frames or samples are then packed into a packet payload, encapsulated into a packet and transmitted. Since each receiver/decoder is paired with a corresponding encoder/transmitter, the channel element is bi-directional.

When a packet is received by the channel element, it is checked for validity by a packet receiver 411 and then sent to a de-jitter/resequencer 412. The de-jitter/resequencer 412 holds the packet until the next packet in sequence arrives. If packets arrive out of order, they are reordered. If a packet fails to arrive within the jitter tolerance of the channel element, an overdue/lost packet indication is sent to the decoder 420.

Once the de-jitter/resequencer 412 has insured that a packet has arrived at the right time and in order, it sends the packet to the packet unbundler 413, which disassembles the packet and its payload into the fundamental units of speech data associated with the vocoder algorithm in the vocoder/transceiver used in this side of the channel element. Depending on the vocoder used in this side of the channel element, these voice data units may be speech frames representing an extended period of speech or they may be speech samples representing an instant of speech. In some cases, the speech data will be interleaved over several packet payloads. In this case, the packet unbundler 413 works with a de-interleaver 414 to recover the voice data into an appropriate order for decoding. Once the speech data units are recovered and in an appropriate order, they are sent to the voice decoder 421.

The voice decoder 421 converts the speech data units received in a packet into a common voice format. In some embodiments, the common format is 16 bit linear speech samples (LSSs) at a sampling rate of 8000 samples per second (sps). That is, the LSSs represent samples of speech separated by 125 microseconds of real-time. The voice decoder 421 is not constrained to create them at this rate. Most voice decoders create a block containing a number of these samples (usually a hundred or more) nearly simultaneously. The voice decoder stores these LSSs into the LSS store 430 as soon as they are created.

A packet may occasionally fail to arrive at the transcoder within the jitter tolerance window established for the channel element or may fail to arrive at all. In either case, the packet will not be available for use by the voice decoder 421. In this case, the de-jitter/resequencer 412 notifies the voice decoder 421 that a packet is late or lost. The voice decoder 421 operates to mitigate packet-errors (overdue packets, etc.) to synthesize LSSs using the mitigation method associated with the voice decoder. A packet-error mitigator 422 works with the voice decoder 421 to “fill in” lost speech data, using well-known methods, with as little impact as practical to the resulting speech quality.

Once the voice encoder 441 determines that there are enough LSSs in the LSS store 430 to begin the encoding process, it retrieves a set of LSSs and encodes it into the speech data unit associated with that encoding algorithm. As in the received case, encoded speech data units may be speech frames representing an extended period of speech or they may be speech samples representing an instant of voice. The voice encoder 441 forwards the encoded speech data units to the packet bundler 451.

The packet bundler 451 assembles encoded speech units into packet payloads as required by the channel element definition. If interleaving is used in the transmitter function on this side of the channel element, the packet bundler 451 works in conjunction with the interleaver 452 to interleave the speech units across multiple payloads in accordance with the interleaving function specified for the channel element. The packet creator 453 then receives the payloads from the packet bundler 451 and encapsulates them in a packet for transport through the network. In some embodiments, the speech payloads are encapsulated into RTP packets.

The primary function of the packet transmitter 454 is to queue the packets from the packet creator 453 and send them into the network at the appropriate time. This process re-synchronizes the packet flow with actual time so that the packets are received at the endpoint of the call with the necessary time relationship so that the speech can be recovered and played out to the user. This resynchronization function of the packet transmitter 454, along with the de-jitter/resequencer 412 in the receiver allows the transcoder to operate the channel element with whatever timing provides the best computational efficiency without having to maintain the real-time relationships in the speech data during the processing.

Other embodiments may use a different common format than 16 bit linear speech samples at 8000 sps. For example, a different number of bits may be used or a different sampling rate. Under some circumstances it may be desirable to use a non-linear unitization, for example the ITU G.711 A-Law or mu-Law. The idea is that all voice decoder functions and all voice encoder functions use a common voice format. This allows any vocoder/transceiver function supported by the transcoder to be operated in tandem with any other vocoder/transceiver supported by the transcoder. It also allows completely new types of vocoder/transceiver functions to be added to the transcoder over time and have these new types of vocoder/transceivers capable of operating in tandem with the older vocoder/transceiver functions without any modification to the older functions.

FIG. 7 is a logic flow diagram of functionality performed by one or more packet-based tandem transcoders, in accordance with multiple embodiments of the present invention. Logic flow 700 begins (702) during call initialization when the transcoder receives (704) the channel element parameters that specify the channel element the transcoder will provide for the call. The transcoder will then begin (706) receiving packets containing encoded voice, formatted in accordance with a first access technology. The transcoder decodes (708) the encoded voice to produce a sequence of linear speech samples.

Depending on the number of target access technologies, the number of target call legs, and/or the network/transcoder architecture employed, one or more encoders in the receiving transcoder or one or more encoders in a networked transcoder begin obtaining (710) the linear speech samples via a non-circuit switched communication path. The one or more encoders then encode (712) the linear speech samples into a format in accordance with the target access technology or technologies. The transcoder or transcoders continue receiving voice packets, decoding into linear speech samples, and encoding into different voice packets for the call duration. When the call ends, logic flow 700 ends (714).

Benefits, other advantages, and solutions to problems have been described above with regard to specific embodiments of the present invention. However, the benefits, advantages, solutions to problems, and any element(s) that may cause or result in such benefits, advantages, or solutions, or cause such benefits, advantages, or solutions to become more pronounced are not to be construed as a critical, required, or essential feature or element of any or all the claims. As used herein and in the appended claims, the term “comprises,” “comprising,” or any other variation thereof is intended to refer to a non-exclusive inclusion, such that a process, method, article of manufacture, or apparatus that comprises a list of elements does not include only those elements in the list, but may include other elements not expressly listed or inherent to such process, method, article of manufacture, or apparatus.

The terms a or an, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically.

What is claimed is:

1. A method for voice transcoding in a voice-over-internet-protocol (VoIP) environment comprising:
receiving packets that include vocoder data frames in which source voice samples have been encoded according to a first vocoding format;
decoding, by a decoder, the vocoder data frames to produce a sequence of linear speech samples;
obtaining, by an encoder via a non-circuit switched communication path, linear speech samples from the sequence of linear speech samples produced by the decoder; and
encoding, by the encoder, groups of speech samples from the sequence of linear speech samples to produce vocoder data frames according to a second vocoding format.

2. The method of claim 1 further comprising:
receiving channel element parameters for use by the decoder and the encoder during a call, wherein the channel element parameters comprise information from the group consisting of packet size limits, packet rates, jitter tolerance windows, and vocoder mode information.

3. The method of claim 1 further comprising:
obtaining, by an additional encoder via a non-circuit switched communication path, linear speech samples from the sequence of linear speech samples produced by the decoder; and
encoding, by the additional encoder, groups of speech samples from the sequence of linear speech samples to produce vocoder data frames according to a third vocoding format.

4. The method of claim 3 wherein the source voice samples comprise voice samples for a multi-party call involving at least three parties.

5. The method of claim 4 wherein the multi-party call comprises at least one call type from the group consisting of a conference call, a dispatch call, and a push-to-talk (PTT) call.

6. A channel element for voice transcoding in a voice-over-internet-protocol (VoIP) environment comprising:
a receiver-decoder
adapted to receive packets that include vocoder data frames in which source voice samples have been encoded according to a first vocoding format and
adapted to decode the vocoder data frames to produce a sequence of linear speech samples;
a linear speech sample store, communicatively coupled to the receiver-decoder,
adapted to store the sequence of linear speech samples; and
an encoder-transmitter, communicatively coupled to the linear speech sample store,
adapted to obtain, via a non-circuit switched communication path, linear speech samples from the sequence of linear speech samples produced by the receiver-decoder and
adapted to encode groups of speech samples from the sequence of linear speech samples to produce encoded data frames according to a second vocoding format.

7. The channel element of claim 6, wherein the linear speech sample store comprises at least one store from the group consisting of a digital signal processor (DSP) memory, a shared DSP memory, and a shared memory.

8. The channel element of claim 6, wherein the non-circuit switched communication path comprises at least one communication pathway from the group consisting of a packet-switched network, a data bus, an inter-DSP signaling bus, and an intra-DSP signaling bus.

9. The channel element of claim 6 communicatively coupled with an additional channel element comprising:
an additional encoder-transmitter, communicatively coupled to the linear speech sample store,
adapted to obtain, via a non-circuit switched communication path, linear speech samples from the sequence of linear speech samples produced by the receiver-decoder and
adapted to encode groups of speech samples from the sequence of linear speech samples to produce encoded data frames according to a third vocoding format.

10. The channel element of claim 6, wherein the receiver-decoder comprises:
a packet receiver adapted to check that the received packets are valid;
a de-jitter-resequencer adapted to reorder packets that are received out of order, adapted to determine whether packets arrive within their jitter tolerance windows, and adapted to indicate to a voice decoder when expected packets are overdue;
a packet unbundler adapted to extract vocoder data frames from the packets and prepare the vocoder data frames for decoding;
the voice decoder adapted to decode the vocoder data frames and invoke a packet-error mitigator for overdue packets to produce a sequence of linear speech samples; and
the packet-error mitigator adapted to synthesize linear speech samples for overdue packets.

11. The channel element of claim 10, wherein the receiver-decoder further comprises
a de-interleaver adapted to restore interleaved voice data in the vocoder data frames to an ordering that can be decoded.

12. The channel element of claim 6, wherein the encoder-transmitter comprises:
a voice encoder adapted to encode groups of speech samples from the sequence of linear speech samples to produce encoded data frames according to a second vocoding format;
a packet bundler adapted to assemble the encoded data frames into packet payloads; and
a packet creator adapted to encapsulate the packet payloads into transport packets.

13. The channel element of claim 12, wherein the encoder-transmitter further comprises
an interleaver adapted to interleave vocoder data frames during assembly into packet payloads;

14. The channel element of claim 6, wherein the encoder-transmitter comprises:
a packet transmitter adapted to queue transport packets for transmission into a target network at targeted intervals in order to re-establish a desired packet flow, wherein the transport packets contain the encoded data frames.

15. The channel element of claim 14, wherein the transport packets comprise RTP packets and wherein the target network comprises an internet protocol (IP) network.

16. The channel element of claim 6, wherein the receiver-decoder is adapted to receive RTP packets via an internet protocol (IP) network.

17. A channel element for voice transcoding in a voice-over-internet-protocol (VoIP) environment comprising:
means for receiving packets that include vocoder data frames in which source voice samples have been encoded according to a first vocoding format;
means for decoding the vocoder data frames to produce a sequence of linear speech samples;
means for obtaining, via a non-circuit switched communication path, linear speech samples from the sequence of linear speech samples produced by the decoding means; and
means for encoding groups of speech samples from the sequence of linear speech samples to produce vocoder data frames according to a second vocoding format.

18. The method of claim 17 further comprising:
an additional means for obtaining, via a non-circuit switched communication path, linear speech samples from the sequence of linear speech samples produced by the decoding means; and
an additional means for encoding groups of speech samples from the sequence of linear speech samples to produce vocoder data frames according to a third vocoding format.
